(19) United States
(12) Patent Application Publication
(10) Pub. No.: US 2016/0348427 A1
(43) Pub. Date: Dec. 1, 2016

(54) NEW-TYPE DRAW CORD STRUCTURE

(71) Applicant: Window Shine Decorative Products Co., Ltd., Qishi Town (CN)

(72) Inventor: Huicai ZHANG, Dongguan (CN)

(21) Appl. No.: 14/806,830

(22) Filed: Jul. 23, 2015

(30) Foreign Application Priority Data
May 28, 2015 (CN) 201510278228.1

(51) Int. Cl. E06B 9/326

(52) U.S. Cl. CPC E06B 9/326

(57) ABSTRACT

The present invention discloses a new-type draw cord curtain structure, including an upper track. A side of a lower end of the upper track is mounted with a moveable curtain body. An upper end of the moveable curtain body is connected with the upper track. The upper track is mounted with a moveable draw cord. One end of the moveable draw cord is connected with the moveable curtain body and the other end of the moveable draw cord droops to the side of the lower end of the upper track across the upper track. The upper track is mounted with a plurality of extension tubes corresponding to the moveable draw cord. Extension tube through holes which are perforated completely from the top down are provided on the cores of the plurality of extension tubes. Upper ends of the plurality of extension tubes are mounted to the upper track.

### FIELD OF THE INVENTION

The present invention relates to the technical field of curtains, and particularly designing a new-type draw cord curtain structure.

### BACKGROUND OF THE INVENTION

As a shading and heat-insulating device for adjusting indoor light, a curtain has been widely applied in places including homes, and workplaces and so on.

There are curtain structure of various forms in the prior art. Curtains may be divided into automatic curtains and manual curtains according to different degrees of automation of opening and closing the curtains, wherein the automatic curtains, which may be opened and closed automatically as required by users, are highly automatic and convenient to use. However, the automatic curtains still have disadvantages of high procurement cost, complicated structure, and bad stability and reliability during practical use.

As a widely-applied manual curtain structure, a draw cord curtain is still favored by many consumers. However, a draw cord curtain must be driven to act only via a draw cord thereof while the draw cord may tighten and injure, or even strangle an infant, which has become a key reason for many parents to concern about draw cord curtains.

### SUMMARY OF THE INVENTION

A purpose of the present invention is to provide a new-type draw cord curtain structure to solve disadvantages of the prior art. The new-type draw cord curtain structure, which is novel in design, simple in structure and convenient to use with good stability and reliability, is able to effectively prevent a draw cord from tightening an infant.

The present invention is implemented by the following technical solution in order to achieve the purpose.

A new-type draw cord curtain structure includes an upper track mounted on a surface of a wall and located at a side of an upper end of a window; the upper track is arranged horizontally and transversely; a side of a lower end of the upper track may be mounted with a moveable curtain body in a relatively moveable manner; an upper end of the moveable curtain body is connected with the upper track;

the upper track may be mounted, in a relatively moveable manner, with a moveable draw cord driving the moveable curtain body to act; one end of the moveable draw cord is connected with the moveable curtain body and the other end of the moveable draw cord droops to the side of the lower end of the upper track across the upper track;

corresponding to the moveable draw cord, the upper track is mounted with a plurality of vertically-arranged extension tubes capable of extending and retracting vertically; extension tube through holes which are perforated completely from the top down are provided on the cores of the plurality of extension tubes; upper ends of the plurality of extension tubes are mounted to the upper track; the moveable draw cord is embedded and inserted in the extension tube through holes of the plurality of extension tubes and an end of the moveable draw cord is connected to a casing at the bottom of the plurality of extension tubes,

wherein the casing at the bottom of the plurality of extension tubes is mounted with a draw cord connector corresponding to the moveable draw cord; the draw cord connector is connected to the end of the moveable draw cord; the draw cord connector is connected to a lower end of the casing at the bottom of the plurality of extension tubes,

wherein the draw cord connector is screwed to the lower end of the casing at the bottom of the plurality of extension tubes,

wherein the draw cord connector is buckled to the lower end of the casing at the bottom of the plurality of extension tubes.

The present invention has a beneficial effect that a new-type draw cord curtain structure of the present invention includes an upper track arranged horizontally and transversely; a side of a lower end of the upper track is mounted with a moveable curtain body; an upper end of the moveable curtain body is connected with the upper track; the upper track is mounted with a moveable draw cord; one end of the moveable draw cord is connected with the moveable curtain body and the other end of the moveable draw cord droops to the side of the lower end of the upper track across the upper track; the upper track is mounted with a plurality of extension tubes corresponding to the moveable draw cord; extension tube through holes which are perforated completely from the top down are provided on the cores of the plurality of extension tubes; upper ends of the plurality of extension tubes are mounted to the upper track; the moveable draw cord is embedded and inserted in the extension tube through holes of the plurality of extension tubes and an end of the moveable draw cord is connected to a casing at the bottom of the plurality of extension tubes. Using a design of a hidden structure of a draw cord, the present invention can effectively avoid risks that an infant is tightened, injured by being tightened or even strangled by the moveable draw cord. That is, the present invention has advantages of novel design, simple structure, convenient use, and good stability and reliability.

### BRIEF DESCRIPTION OF THE DRAWINGS

The present invention will be further described below by using the accompanying drawings, but the embodiments in the accompanying drawings do not constitute any limitation to the present invention.

FIG. 1 is a structural diagram of the present invention.

### DETAILED DESCRIPTION OF THE PREFERRED EMBODIMENTS

The present invention will be described hereinafter in combination with specific embodiments.

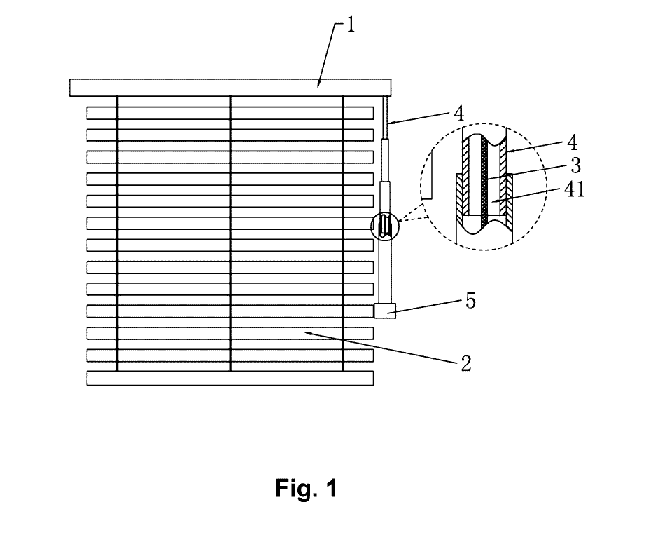

As shown in FIG. 1, a new-type draw cord curtain structure includes: an upper track 1 mounted on a surface of a wall and located at a side of an upper end of a window. The upper track 1 is arranged horizontally and transversely. A side of a lower end of the upper track 1 may be mounted with a moveable curtain body 2 in a relatively moveable manner. An upper end of the moveable curtain body 2 is connected with the upper track 1.

Further, the upper track 1 may be mounted, in a relatively moveable manner, with a moveable draw cord 3 driving the moveable curtain body 2 to act. One end of the moveable draw cord 3 is connected with the moveable curtain body 2 and the other end of the moveable draw cord 3 droops to the side of the lower end of the upper track 1 across the upper track 1.

Further, corresponding to the moveable draw cord 3, the upper track 1 is mounted with a plurality of vertically-arranged extension tubes 4 capable of extending and retracting vertically. Extension tube through holes 41 which are perforated completely from the top down are provided on the cores of the plurality of extension tubes 4. Upper ends of the plurality of extension tubes 4 are mounted to the upper track 1. The moveable draw cord 3 is embedded and inserted in the extension tube through holes 41 of the plurality of extension tubes 4 and an end of the moveable draw cord 3 is connected to a casing at the bottom of the plurality of extension tubes 4.

During a working process of the present invention, a user only needs to hold the casing at the bottom of the plurality of extension tubes 4 and push the casing at the bottom of the plurality of extension tubes 4 upwards or pull the same downwards when the user needs to drive the moveable curtain body 2 to act. During this process, the moveable draw cord 3 moves upwards or downwards with the casing at the bottom of the plurality of extension tubes 4. That is, the user only needs to operate the plurality of extension tubes 4 to drive the moveable curtain body 2 to act.

It needs to be further pointed out that a drooping part of the moveable draw cord 3 of the present invention is hidden inside the plurality of extension tubes 4. The structural design can effectively prevent an infant from touching the moveable draw cord 3, thus further effectively preventing the moveable draw cord 3 from tightening the infant, injuring the infant by tightening or even strangling the infant.

It may be learned by summing up the foregoing conditions that, using a design of a hidden structure of a draw cord, the present invention can effectively avoid risks that an infant is tightened, injured by being tightened or even strangled by the moveable draw cord 3. That is, the present invention has advantages of novel design, simple structure, convenient use, and good stability and reliability.

As a preferred embodiment, the present invention applies the following structural design as shown in FIG. 1 to facilitating connection of the moveable draw cord 3 and the casing at the bottom of the plurality of extension tubes 4. Specifically, the casing at the bottom of the plurality of extension tubes 4 is mounted with a draw cord connector 5 corresponding to the moveable draw cord 3. The draw cord connector 5 is connected to the end of the moveable draw cord 3. The draw cord connector 5 is connected to a lower end of the casing at the bottom of the plurality of extension tubes 4.

Further, the draw cord connector 5 and the lower end of the casing at the bottom of the plurality of extension tubes 4 may be installed and connected through a screw connection manner, and may be also installed and connected through a buckle connection manner. Of course, the installation and connection methods do not constitute limitation to the present invention. That is, the draw cord connector 5 and the plurality of extension tubes 4 may be further installed and connected by utilizing other methods, e.g. a casing and clamping method and so on.

The foregoing content is only a preferred embodiment of the present invention. For those of ordinary skills in the art, specific embodiments and application may change according to the idea of the present invention. The content of the specification should be understood as limitation to the disclosure.

What is claimed is:

1. A new-type draw cord curtain structure, wherein it includes an upper track (1) mounted on a surface of a wall and located at a side of an upper end of a window; the upper track (1) is arranged horizontally and transversely; a side of a lower end of the upper track (1) may be mounted with a moveable curtain body (2) in a relatively moveable manner; an upper end of the moveable curtain body (2) is connected with the upper track (1);
the upper track (1) may be mounted, in a relatively moveable manner, with a moveable draw cord (3) driving the moveable curtain body (2) to act; one end of the moveable draw cord (3) is connected with the moveable curtain body (2) and the other end of the moveable draw cord (3) droops to the side of the lower end of the upper track (1) across the upper track (1);
corresponding to the moveable draw cord (3), the upper track (1) is mounted with a plurality of vertically-arranged extension tubes (4) capable of extending and retracting vertically; extension tube through holes (41) which are perforated completely from the top down are provided on the cores of the plurality of extension tubes (4); upper ends of the plurality of extension tubes (4) are mounted to the upper track (1); the moveable draw cord (3) is embedded and inserted in the extension tube through holes (41) of the plurality of extension tubes (4) and an end of the moveable draw cord (3) is connected to a casing at the bottom of the plurality of extension tubes (4).

2. A new-type draw cord curtain structure according to claim 1, wherein the casing at the bottom of the plurality of extension tubes (4) is mounted with a draw cord connector (5) corresponding to the moveable draw cord (3); the draw cord connector (5) is connected to the end of the moveable draw cord (3); the draw cord connector (5) is connected to a lower end of the casing at the bottom of the plurality of extension tubes (4).

3. A new-type draw cord curtain structure according to claim 2, wherein the draw cord connector (5) is screwed to the lower end of the casing at the bottom of the plurality of extension tubes (4).

4. A new-type draw cord curtain structure according to claim 2, wherein the draw cord connector (5) is buckled to the lower end of the casing at the bottom of the plurality of extension tubes (4).
